(19) United States
(12) Patent Application Publication
(10) Pub. No.: US 2009/0320242 A1
(43) Pub. Date: Dec. 31, 2009

(54) HINGE

(75) Inventor: CHEN-WEI CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/211,819

(22) Filed: Sep. 17, 2008

(30) Foreign Application Priority Data
Jun. 26, 2008 (CN) 200820301320.0

(51) Int. Cl. E05D 7/06

(52) U.S. Cl. 16/250; 16/277

(57) ABSTRACT

A hinge includes a shaft including a post, a first interfering member, a second interfering member, a bracket, two washers mounted on the post, a resilient assembly located on the post, and a fastener engaging with the post and exerting force against the washers and the resilient assembly. The first interfering member includes a sleeve portion the opposite ends of which define two openings, and a bottom plate covering one of the openings. The bottom plate defines a through hole through which the post extends. A first depressed portion is formed from the inner surface of the bottom plate. The second interfering member defines a through hole fitting about the post. A first raised portion is formed from one side of the second interfering member engaging with the first depressed portion. The bracket includes a flange defining a hole fitting about the post.

### BACKGROUND

1. Field of the Invention

The disclosure relates to device construction, and particularly, to a hinge.

2. Description of Related Art

A collapsible device, such as a notebook computer or clamshell mobile phone, generally includes two parts pivotally connected via a hinge. A conventional hinge includes a bracket mounted to one part and a shaft with one end mounted to the other. The bracket includes a barrel rotatably receiving an opposite end of the shaft.

Conventionally, friction between the shaft and the barrel is insufficient to fix the two parts at a desired angle after the opening.

Therefore, the invention provides a hinge to obviate the described limitations.

### BRIEF DESCRIPTION OF THE DRAWINGS

FIG. 1 is an assembled, isometric view of an exemplary embodiment of a collapsible device including a hinge.

FIG. 2 is an exploded, isometric view of the hinge of FIG. 1.

FIG. 3 is another exploded, isometric view of the hinge of FIG. 1, but from a different perspective, with the hinge including a first interfering member.

FIG. 4 is an enlarged, partially cutaway view of the interfering member of FIG. 3, but from a different perspective.

FIG. 5 is an assembled, isometric view of the hinge of FIG. 3, but from a different perspective.

FIG. 6 is an exploded, isometric view of another embodiment of a hinge.

### DETAILED DESCRIPTION

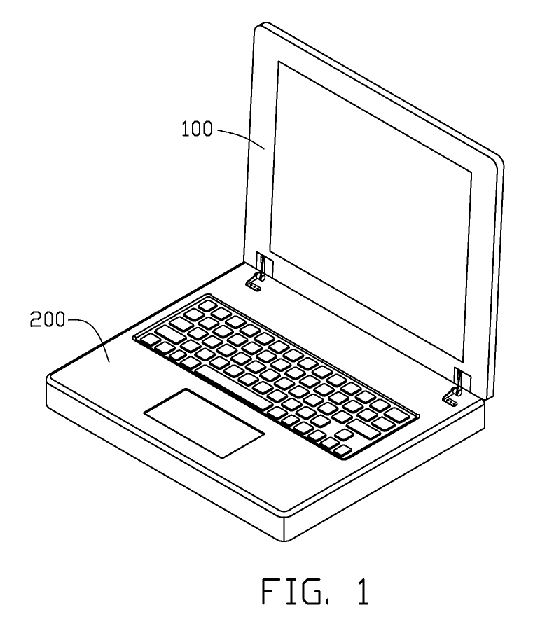

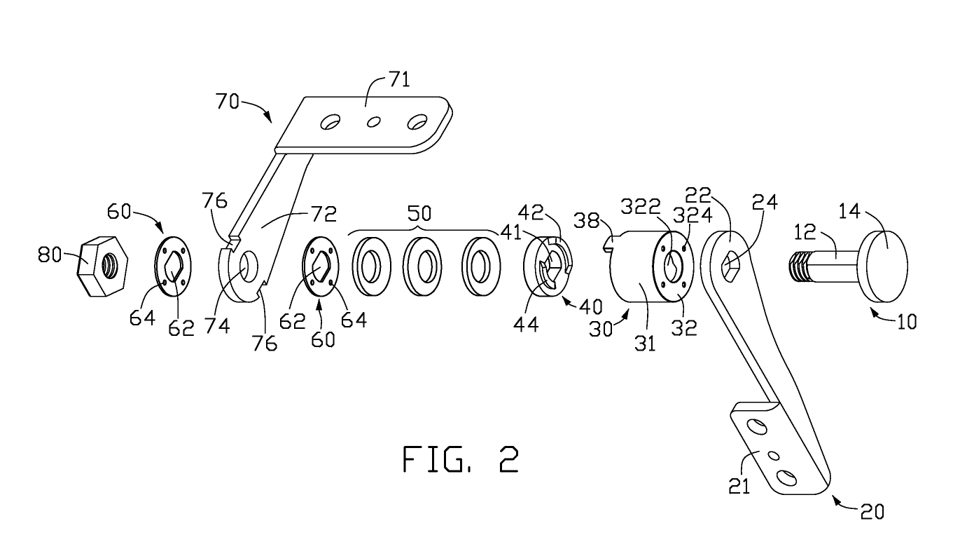

Referring to FIGS. 1 and 2, a hinge mounted to a collapsible device connects a first assembly 100 to a second assembly 200. In a first embodiment of the disclosure, the hinge includes a shaft 10, a rack 20, a first interfering member 30, a second interfering member 40, a resilient assembly 50, two washers 60, a bracket 70, and a fastener 80.

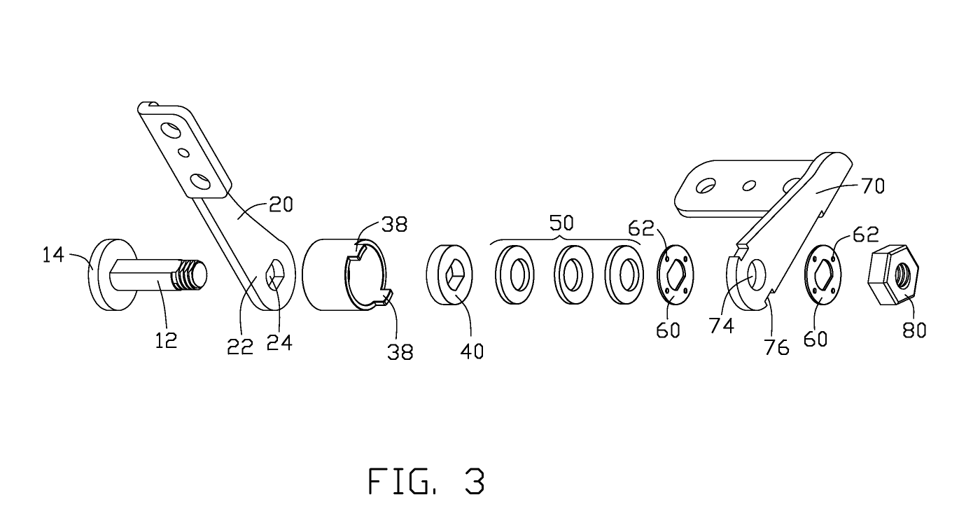

Referring to FIG. 3, the shaft 10 includes a non-cylindrical post 12 and a head 14 formed at an end thereof. A threaded portion is formed on the opposite end of the post 12.

The rack 20 includes a main body 21 and a flange 22 extending perpendicularly from a side of the main body 21. The flange 22 defines a non-circular locating hole 24 configured to snugly fit about the post 12. The main body 21 defines a plurality of mounting holes through which a plurality of screws extend, capable of being locked to the first assembly 100.

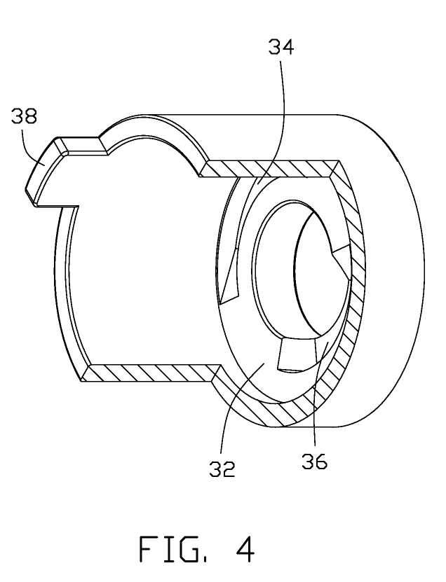

Referring to FIG. 4, the first interfering member 30 includes a sleeve portion 31, opposite ends of which define two openings, and a bottom plate 32 covering one opening of the sleeve portion 31. The bottom plate 32 defines a round through hole 322 in the center thereof. The through hole 322 allows the first interfering member 30 to rotatably fit about the post 12 of the shaft 10. A plurality of salient points 324 extend from the outer surface of the bottom plate 32, providing friction between the first interfering member 30 and the rack 20. The bottom plate 32 defines a curved first depressed portion 34 in the inner surface adjacent to the sleeve portion 30. The bottom plate 32 defines a curved second depressed portion 36 in the inner surface thereof adjacent to the through hole 322. The first and second depressed portions 34, 36 are opposite each other across the through hole 322. Two opposite tabs 38 extend from the sleeve portion 31 opposite to the bottom plate 32.

The second interfering member 40 defines a non-circular through hole 41 in a center, configured to snugly fit about the post 12. A first raised portion 42 and a second raised portion 44 are formed from one side of the second interfering member 40, corresponding to the first and second depressed portions 34, 36 of the first interfering member 30.

The resilient assembly 50 includes a plurality of resilient washers each defining a round through hole in a center thereof. The post 12 of the shaft 10 is insertable into the through holes of the resilient washers, rendering the shaft 10 rotatable relative to the resilient washers.

The bracket 70 includes a main body 71 and a flange 72 extending from a side thereof. The flange 72 defines a round pivoting hole 74 rotatably fitting about the post 12 of the shaft 10. Thus, the shaft 10 is rotatable relative to the bracket 70. The main body 71 defines a plurality of mounting holes through which a plurality of screws extend, lockable to the second assembly 200. The flange 72 defines two opposite cutouts 76 across the pivoting hole 74.

The washers 60 are located at opposite sides of the flange 72, thereby sandwiching the flange 72 of the bracket 70 therebetween. Each of the washers 60 defines a non-circular through hole 62 in a center thereof, configured to snugly fit about the post 12. A plurality of salient points 64 extend from two opposite surfaces of each of the washers 60, providing friction between the bracket 70 and the washers 60.

In this embodiment, the fastener 80 is a nut capable of engaging the threaded portion of the post 12, pressing firmly against the rack 20, the first interfering member 30, the second interfering member 40, the resilient assembly 50, the washers 60, and the bracket 70.

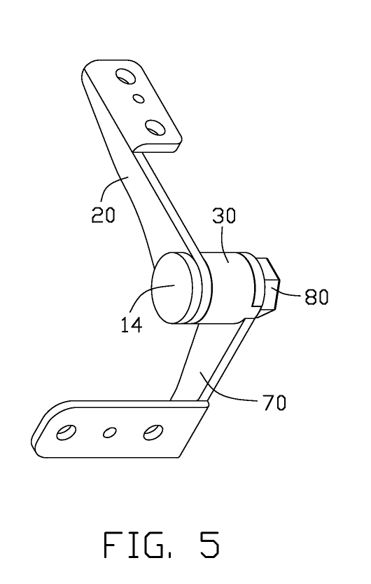

Referring to FIG. 5, in assembly, the post 12 of the shaft 10 is inserted through the locating hole 24 of the rack 20, the through hole 322 of the first interfering member 30, the through hole 41 of the second interfering member 40, the through holes of the resilient washers of the resilient assembly 50, the through hole 62 of one of the washers 60, the pivoting hole 74 of the bracket 70, and the through hole 62 of the other washer 60, in order. The fastener 80 engages the threaded portion of the post 12. The second interfering member 40, the resilient assembly 50, and one washer 60 adjacent to the resilient assembly 50 are received in the sleeve portion 31 of the first interfering member 30. The tabs 38 of the first interfering member 30 engage the corresponding cutouts 74 of the bracket 70.

In use, the main body 21 of the rack 20 is fixed to the first assembly 100 of the collapsible device. The main body 71 of the bracket 70 is fixed to the second assembly 200 of the collapsible device. When the first assembly 100 covers the second assembly 200, the first and second raised portions 42, 44 of the second interfering member 40 engage the corresponding first and second depressed portions 34, 36 of the first interfering member 30. When the first assembly 100 is rotated away from the second assembly 200, the rack 20 and the shaft 10 rotate the second interfering member 40 and the washers 60. The first and second raised portions 42, 44 of the second interfering member 40 are moved out of the first and second depressed portion 34, 36 of the first interfering member 30 and move along the inner surface of the bottom plate 32 of the first interfering member 30, moving the second interfering member 40 away from the bottom plate 32 of the first interfering member 30. As a result, the second interfering member 40 presses the resilient assembly 50, one washer 60, and the flange 72 of the bracket 70 to abut against the other washer 60, providing friction therebetween.

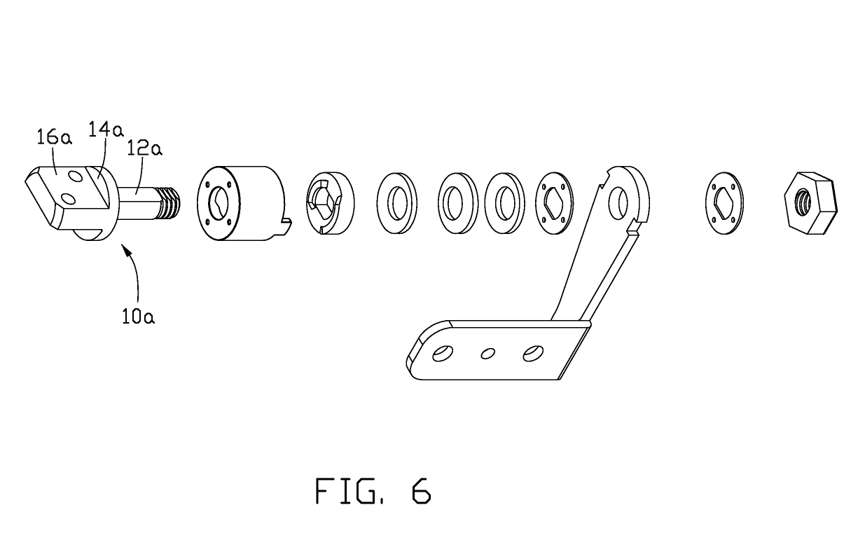

Referring to FIG. 6, a hinge of a second embodiment of the disclosure is similar to that of the first embodiment, differing in the absence of the rack 20 for being fixed to the first assembly 100. The hinge of the second embodiment includes a shaft 110a. The shaft 110a includes a non-cylindrical post 12a, a mounting portion 16a, and a flange 14a formed between the post 12a and the mounting portion 16a. A threaded portion is formed on the post 12a, opposite to the flange 14a. The mounting portion 16a defines a plurality of mounting holes through which a plurality of screws extend, to be locked to the first assembly 100.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a shaft comprising a post;
a first interfering member comprising a sleeve portion, opposite ends of which define two openings, and a bottom plate covering one of the openings, the bottom plate defining a through hole in a center for rotatably fitting about the post of the shaft, a first depressed portion defined in an inner surface of the bottom plate and facing the other opening of the sleeve portion;
a second interfering member defining a through hole snugly fitting about the post of the shaft, a first raised portion formed from one side of the second interfering member corresponding to the first depressed portion of the first interfering member, engaging with the first depressed portion of the first interfering member;
a bracket comprising a flange defining a hole for fitting about the post of the shaft;
two washers fitting about the post;
a resilient assembly fitting about the post; and
a fastener engaging with the post and exerting force against the washers, and the resilient assembly.

2. The hinge of claim 1, wherein the post has a non-circular cross-section.

3. The hinge of claim 2, wherein each of the washers defines a non-circular through hole, configured for snugly fitting about the post.

4. The hinge of claim 3, wherein the washers are located at opposite sides of the flange of the bracket, and sandwiches the flange between them.

5. The hinge of claim 3, wherein a plurality of salient points are formed from at least one side of each of the washers.

6. The hinge of claim 2, wherein a round pivoting hole is defined in the flange of the bracket, and the through hole rotatably fitting about the post.

7. The hinge of claim 1, wherein the resilient assembly comprises a plurality of resilient washers each defining a round through hole in a center, for rotatably fitting about the post of the shaft.

8. The hinge of claim 1, wherein at least one cutout is defined in the flange of the bracket, at least one tab extends from the sleeve portion of the first interfering member opposite to the bottom plate, to engage the at least one cutout, thereby snugly mounting the first interfering member to the bracket.

9. The hinge of claim 1, wherein the second interfering member, the resilient assembly, and one of the washers are received in the sleeve portion of the first interfering member.

10. The hinge of claim 1, further comprising a rack snugly fitting about the post, wherein the rack neighbors the bottom plate of the first interfering member and opposite to the second interfering member, and a plurality of salient points from an outer surface of the bottom plate provide friction between the bottom plate and the rack.

11. The hinge of claim 1, wherein a second depressed portion is formed from the inner surface of the bottom plate of the first interfering member; and a second raised portion is defined in the side of the second interfering member, engaging the second depressed portion.

12. The hinge of claim 11, wherein the first and second depressed portions of the first interfering member are opposite each other across the through hole of the bottom plate; and the first and second raised portions of the second interfering member are opposite each other across the through hole of the second interfering member.

13. A collapsible device, comprising:
a first assembly;
a second assembly;
a shaft fixed to the first assembly, the shaft comprising a post;
a first interfering member comprising a sleeve portion, and a bottom plate covering an end of the sleeve portion; the bottom plate defining a through hole in a center for rotatably fitting about the post of the shaft; and a first depressed portion defined in an inner surface of the bottom plate, facing the other end of the sleeve portion;
a second interfering member defining a through hole snugly fitting about the post of the shaft, and a first raised portion formed from one side of the second interfering member, engaging the first depressed portion of the first interfering member;
a bracket fixed to the second assembly, comprising a flange defining a hole fitting about the post of the shaft;
two washers fitting about the post;
a resilient assembly fitting about the post; and
a fastener engaging the post and exerting force against the washers and the resilient assembly.

14. The collapsible device of claim 13, further comprising a rack, wherein the rack comprises a main body and a flange extending from a side of the main body; the flange defines a locating hole fitting about the post of the shaft; and the main body defines a plurality of mounting holes through which a plurality of screws extend to fix to the first assembly.

15. The collapsible device of claim 14, wherein the post has a non-circular cross-section; the locating hole of the flange of the rack is non-circular, and the rack snugly fits about the post of the shaft.

16. The collapsible device of claim 13, wherein the shaft further comprises a mounting portion, and the mounting portion defines a plurality of mounting holes through which a plurality of screws extend to fix to the first assembly.

17. The collapsible device of claim 13, wherein the bracket further comprises a main body defining a plurality of mounting holes through which a plurality of screws extend to fix to the second assembly.
